(19) United States
(12) Patent Application Publication
(10) Pub. No.: US 2007/0019152 A1
(43) Pub. Date: Jan. 25, 2007

(54) Holographic diffraction grating, process for its preparation and opto-electronic devices incorporating it

(76) Inventors: Robert Caputo, Rende (Cosenza) (IT); Cesare Umeton, Rende (IT); Alessandro Veltri, Cosenza (IT); Audrey Sukhov, Moscow (RU); Nelson Tabiryan, Winter Park, FL (US)

Correspondence Address: SUGHRUE MION, PLLC, 2100 PENNSYLVANIA AVENUE, N.W., SUITE 800, WASHINGTON, DC, 20037, US

(21) Appl. No.: 10/563,873

(22) PCT Filed: Jul. 8, 2004
(86) PCT No.: PCT/IB04/51174

§ 371 Date: May 26, 2006

(30) Foreign Application Priority Data
Jul. 9, 2003 (IT) TO2003A000530

(51) Int. Cl. G02F 1/13

(52) U.S. Cl. 349/192

(57) ABSTRACT

Composite polymer/liquid crystal material having a holographic grating structure formed by an alternating ordered succession of polymer layers and nematic liquid crystal layers. The nematic liquid crystal layers comprise an ordered nematic monophase region which is substantially free from liquid crystal droplets.

This invention relates to composite polymer/liquid crystal materials having a holographic grating structure, a process for their preparation and opto-electronic devices incorporating such holographic gratings.

Since the work of Sutherland et al., in the early 90s [1, 2] the use of Polymer Dispersed Liquid Crystals (hereinafter PDLC) for electrically switchable holographic diffraction devices has been a subject of primary interest [3, 4] in the field of electro-optical devices based on PDLC.

In the patent literature PDLC devices are described for example in U.S. Pat. No. 4,891,152, U.S. Pat. No. 4,938,568, U.S. Pat. No. 5,096,282 and U.S. Pat. No. 5,867,238.

The present technique for manufacturing holographic diffraction gratings is based on the use of liquid crystals in solution with a photosensitive prepolymer. Polymerisation of the prepolymer (curing) is photoinduced using laser radiation (visible or near UV). If an interference pattern is formed on the sample being cured (liquid crystal and prepolymer) the polymerisation process is not homogeneous in the areas which are illuminated and the areas on which the light radiation is not incident. Gratings consisting of layers of polymer alternating with layers of PDLC which can be used in various electro-optical devices such as filters, optical switches, optical memories, etc., are manufactured through this technique of photoinduced polymerisation.

Notwithstanding the fact that these gratings have optimum diffraction efficiency (approximately 95% ) and a low manufacturing cost, they incur high losses due to scattering if the wavelength of the incident radiation is comparable with the dimensions of the drops of liquid crystal (nematic droplets) dispersed within the polymer matrix which form during the photopolymerisation stage. The presence of these small nematic domains also requires a high switching voltage.

An appreciable reduction in scattering losses has been achieved by reducing the mean dimensions of the nematic droplets to values below 100 nm through specific choice of the composition of prepolymer and initiator designed to achieve very rapid polymerisation; typical grating manufacture (curing) times are of the order of 30-50 seconds. Very rapid polymerisation makes it possible to obtain a highly cross-linked and mechanically rigid polymer, with the result that the nematic droplets cannot reach their thermodynamic equilibrium dimensions. This approach, although suitable for achieving a high Diffraction Efficiency (DE) and low scattering losses, nevertheless has considerable disadvantages. The first relates to preparation of the prepolymer mixture—the technology for preparation of the different materials is quite complex, in particular in connection with the need for quite precise metering of the components; the mixture has virtually no shelf-life and the preparation process must be performed in a dark chamber because of the extreme sensitivity of the materials to light. Thus most of the commercially available components for preparing PDLC cannot be used in the context of this technological approach. Furthermore, reduction of the droplet dimensions results in a consequent rise in the switching voltages which are necessary in order to align the liquid crystal within the droplets.

Another approach proposed in the literature to overcome the occurrence of scattering phenomena relates to the acquisition of a grating structure formed by an alternating and ordered succession of polymer layers and homogeneous layers of nematic liquid crystal (NLC).

With this object, the publication by R. Caputo et al. [5] describes a holographic grating formed by a spatially periodic sub-micron structure consisting of a sequence of orientated layers of nematic liquid crystal separated by isotropic polymer walls. This structure is obtained by means of a preparation process which comprises heating an initial solution of monomer and liquid crystal to a temperature which is higher than the nematic/isotropic phase transition temperature. This heat treatment is stated by the authors as being capable of preventing the occurrence of I→N phase transitions in microregions of the LC component and therefore of preventing the formation of small nematic domains, which cause scattering of the radiation which propagates within the sample.

This invention relates to a further improvement in the scope of the technology described in previously cited document [5] and provides holographic gratings formed by an alternating succession of polymer layers and layers of nematic liquid crystal in which the areas of liquid crystals are present in a single perfectly orientated nematic domain and therefore have improved diffraction efficiency, a low switching voltage and a high switching efficiency.

The composite materials having a holographic grating structure to which the invention relates are defined in the following claims.

The invention also comprises within its scope a process for preparing the aforesaid composite materials, as well as electro-optical devices which include holographic gratings according to the invention.

It is felt that the new structure of composite material to which the invention relates is due to the new process of preparation which includes obtaining continuous layers of nematic liquid crystal comprising a single monophase region which is wholly free from droplets of liquid crystal. In particular the preferred preparation process which brings about production of the new structure comprises the following operations:
a) preliminary heating of a composition in a thin layer (sample having a thickness of 10-100 μm) of photoinitiator, monomer and nematic liquid crystal up to a temperature above the nematic/isotropic transition temperature of the liquid crystal component; this stage prevents the formation of regions in nematic phase (droplets) during the subsequent curing treatment.
b) illumination of the sample with an interference pattern for UV (or visible or IR) radiation able to cause polymerisation of the monomer; the ideal wavelength and energy density required, and the exposure time, are determined by the particular type and concentration of the photoinitiator used, and the concentration of the solution and the type of liquid crystal used. During this stage polymerisation takes place in the isotropic phase and prevents both transition of the mesogenic material into the nematic liquid crystal phase and phase separation and the consequent formation of droplets. The sample obtained at the end of this stage is referred to as pre-grating.
c) slow cooling of the sample (pre-grating) below the isotropic/nematic transition temperature at the end of the photopolymerisation process. Within the context of the invention, by slow cooling is in general meant conditioned or thermostabilised cooling, that is a rate of cooling which is less than that which would be produced spontaneously as a result of the temperature difference between the sample and the environment.

Generally a rate of cooling of between 0.1 and 0.3° C./minute (preferably approximately 0.2° C./minute) is used. Slow cooling permits complete orientation of the liquid crystal director along a single direction and, as a consequence, the production of a highly ordered structure characterised by high performance, in particular a diffraction efficiency of more than 95% and a switching efficiency of up to 90%.

The method of preparation according to the invention may be applied to an extensive range of liquid crystals and photopolymerisable monomers and does not appear to be restricted to a specific choice of material.

The photopolymerisable prepolymers which can be used in the context of the invention are in themselves known and do not require special description. In particular, prepolymer systems based on acrylates, such as those for example described in the technical and patents literature relating to PDLC, are used; in particular the materials described in U.S. Pat. No. 5,942,157 may be used, the text of which is to be understood to be incorporated herein by reference.

It is preferable to use monomers and nematic liquid crystals which are soluble or miscible with each other.

Further characteristics of the composite materials to which the invention relates and the preparation process will be apparent from the following embodiments which are not to be understood restrictively.

### IN THE APPENDED DRAWINGS

FIG. 1 indicates diagrammatically the geometry used for the sample curing treatment and for the diffraction efficiency (DE) test,

FIGS. 2 and 3 are photomicrographs which illustrate the morphology of the holographic grating obtained according to the invention and according to conventional techniques.

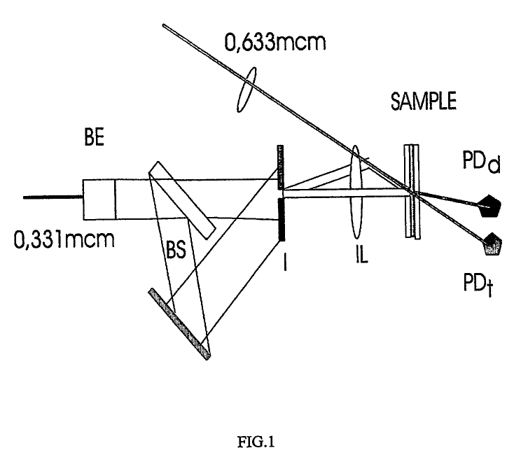

With reference to FIG. 1, the s-polarized radiation having from an Ar ion laser operating at a wavelength of λ_{B}=0.351 μm in single transverse mode is broadened to a diameter of approximately 25 mm through a beam expander BE. The light emitted, whose power is controlled within the range between 3 and 100 mW, is divided into two beams having approximately the same intensity (I₁/I₂=0.95 ±0.02) by beam splitter BS. These beams form an interference pattern when they intersect in the plane of tuneable aperture I.The latter is used to cut off the wings of the transverse intensity profile; in this way the intensity within the aperture (2- 5 mm diameter) is uniform with an accuracy of 4-5%.

The space period Λ of the interference pattern is controlled by adjusting the angle of intersection between the two beams. The aperture may be either imaged at the entrance plane of the sample by a lens (in the case of small intersection angles) or immediately attached to the sample (when the intersection angles are large). In this way the curing process takes place under an effect of an interference pattern of nearly unit contrast. The temperature of the sample is controlled by means of a heat stabilised holder.

The part of the experimental equipment relating to the measurement of DE makes use of an s-polarized and slightly focused (spot diameter on the sample approximately 1 mm) He-Ne radiation, with λ_{R}=0.632 μm. This radiation is used as the “probe” beam and its angle of incidence is controlled to satisfy the Bragg condition for the first order diffracted beam. The DE is deduced by measuring the intensity of either the transmitted beam (order 0) or the first order diffracted beam.

Holographic gratings obtained according to the invention and according to conventional techniques (comparative tests) using the various prepolymer mixtures mentioned below were tested. The gratings had a thickness of 8 μm and were held between two glasses covered with ITO.

i) 5CB NLC diluted in SAM-114 prepolymer mixture (both commercially available from Merck); this mixture is a conventional acrylate-based prepolymer mixture, the components being highly soluble in each other. The 5CB concentration is thermodynamically stable from 0 to 95% by weight, giving a homogeneous isotropic liquid mixture;

ii) BL036 NLC (Merck) diluted in SAM-114; this NLC is less soluble in the prepolymer mixture and undergoes phase separation at ambient temperatures for NLC concentrations in excess of 55% by weight,

iii) 5CB NLC diluted in NOA 65 (Norland Products);

iv) E7 (Merck) diluted in NOA61 (Norland Products); the NLC concentration varied in the range between 17 and 25% by weight.

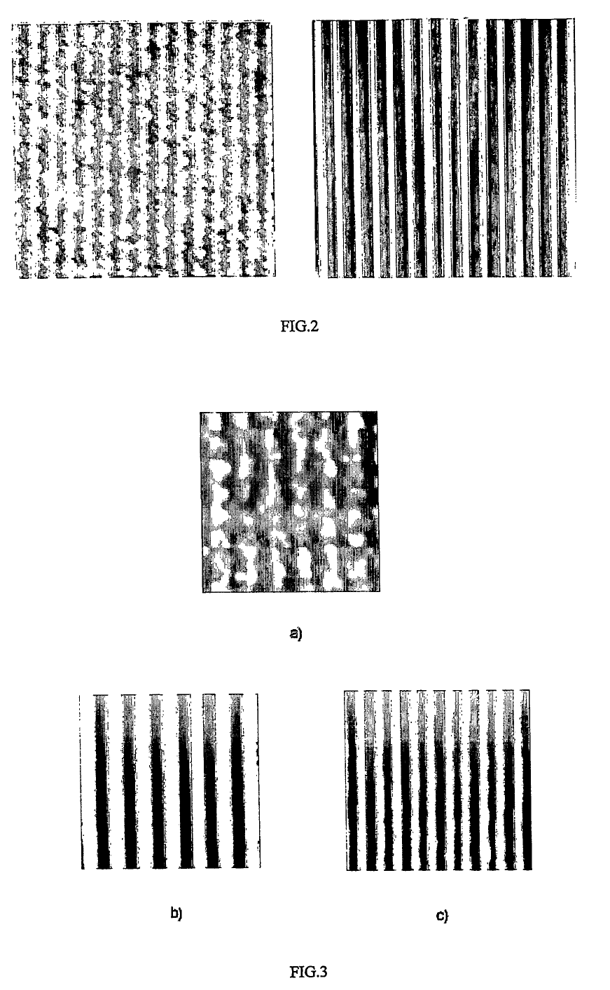

Mixtures i) and ii) revealed an extremely low diffraction efficiency (less than 10% for i) and less than 1% for ii)) when subjected to curing using the conventional technique at ambient temperature. In that case quite large (2-4 μm) nematic droplets aligned in a random way were undoubtedly present in the fringes; see FIG. 2a, in which the distance between the fringes is Λ=6.3 μm.

When the same mixture is subjected to curing using the technique according to the invention a diffraction efficiency of the order of 25% is obtained (maximum theoretical efficiency: ˜33%).

The morphology of the gratings obtained has been observed using a polarising microscope (standard optics) with a resolution of 0.5 μm; the images were acquired in digital mode using a standard CCD camera. These gratings are constituted by a sequence of polymer layers alternating with NLC layers in the nematic phase, with sharp edges, the director of which is uniformly aligned (FIG. 2b). It is emphasised that both the morphologies illustrated in FIG. 2 were obtained starting from the same NLC-prepolymer mixture (60% of 5CB in SAM-114) and making use of the same UV curing intensity (I_{B}=5 mW/cm²), but using two different curing techniques (the conventional technique and the technique according to the invention).

Similar results were obtained starting with mixtures of type ii) (FIG. 3). The switching voltages measured varied from 2.5 V/μm to 3 V/μm for conventional PDLC gratings with a spacing between fringes of 5 μm obtained using both mixtures i) and ii), while for the gratings according to the invention the switching voltages reached minimum values down to 0.8 V/μm.

Electro-optical devices comprising a holographic grating according to the invention are included within the scope of the invention. The possibility of using gratings according to the invention as switchable beam deflectors inserted in optical networks is of particular interest. A grating according to the invention can undoubtedly act as a beam deflector, which can be switched by means of an external control signal, depending upon its particular geometry.

Two different devices which use gratings inserted in a planar waveguide are of primary interest for optical communications:
a) a wavelength filter for which the starting point may be represented by a planar waveguide in which a narrow gap has been produced; the gap is subsequently filled with the mixture necessary to form the grating. The prototype Bragg reflection filter is therefore obtained by curing a grating according to the invention (between two consecutive portions of a planar waveguide), the spatial period of which gives rise to a very narrow reflection band,
b) a tuneable holographic beam splitter obtained by replacing the intersecting part of two intersecting planar waveguides with a grating according to the invention. In this case, in order to obtain high switching efficiency it is necessary to achieve perfect wave-matching between the grating's diffraction orders and the waveguide's intrinsic modes.

### CITED REFERENCES

1) R. L. Sutherland, V. P. Tondiglia, L. V. Natarajan, T. J. Bunning—Chem. Mater., 5, 1533 (1993)

2) R. L. Sutherland, V. P. Tondiglia, L. V. Natarajan, Appl. Phys. Lett., 64, 1074 (1994)

3) R. L. Sutherland, V. P. Tondiglia, L. V. Natarajan, T. J. Bunning, W. W. Adams—J. Nonlinear Opt. Phys&Materials, 5, 89 (1996)

4) R. L. Sutherland, V. P. Tondiglia, L. V. Natarajan, T. J. Bunning, W. W. Adams—Opt. Lett., 20, 1325 (1995)

5) R. Caputo, A. V. Sukhov, C. Umeton, R. F. Ushakov—J. of Experimental and Theoretical Physics, vol. 91, No. 6, 2000, pp. 1190-1197.

1. Polymer/liquid crystal composite material with a holographic grating structure formed by an alternating ordered succession of polymer layers and layers of nematic liquid crystal, characterised in that the said nematic liquid crystal layers comprise a homogeneous nematic monophase region which is substantially free from droplets of liquid crystal.

2. Composite material according to claim 1, characterised in that is obtainable through the operations of:
exposing a mixture comprising photoinitiator, monomer and nematic liquid crystal to an external agent selected from a temperature change and electromagnetic radiation capable of causing reversible loss of the crystalline order of the mesogenic component of the mixture,
illuminating the composition through a radiation interference pattern capable of causing polymerisation of the illuminated regions,
allowing the mesogenic material in the composition to reestablish the crystalline order through a slow decrease in the influence of the external agent.

3. Composite material according to claims 1 or 2, characterised in that it comprises the operations of:
heating the said photoinitiator, monomer and nematic liquid crystal composition to a temperature above the nematic/isotropic phase transition temperature,
illuminating the composition through a UV, visible or IR radiation interference pattern capable of causing polymerisation of the monomer,
slow cooling of the composition below the isotropic/nematic transition point at the end of the polymerisation (curing) process in the absence of curing radiation.

4. Process according to claim 3, in which the said slow cooling of the composition is effected through thermal stabilisation of the composition.

5. Composite material according to claims 3 or 4, in which the said slow cooling is effected at a rate of cooling of between 0.1 and 0.3° C./minute.

6. Composite material according to any of the preceding claims, in which the layers of nematic liquid crystal contain colouring molecules or particles of nanometric dimensions or other doping agents.

7. Composite material according to any of the preceding claims, in which the polymer materials contain photosensitive or conducting or magnetic doping agents or fragments of polymer chains.

8. Composite material according to any of the preceding claims, in which the mesogenic component of the mixture contains doping agents capable of causing a reversible isothermic transition within the nematic isotropic phase under the influence of the curing radiation or other radiation.

9. Process for the preparation of a holographic grating formed by an alternating ordered succession of polymer layers and nematic. liquid crystal layers, characterised in that it comprises the operations of:
exposing a mixture comprising photoinitiator, monomer and nematic liquid crystal to an external agent, selected from a temperature change and electromagnetic radiation capable of causing reversible loss of the crystalline order of the mesogenic component of the mixture,
illuminating the composition with an interference pattern of radiation capable of causing polymerisation of the illuminated regions,
allowing the mesogenic material in the composition to reestablish the crystalline order through a slow decrease in the influence of the external agent.

10. Process according to claim 9, characterised in that it comprises the operations of:
heating the said photoinitiator, monomer and nematic liquid crystal composition to a temperature above the nematic/isotropic phase transition temperature,
illuminating the composition with an interference pattern of UV, visible or IR radiation capable of causing polymerisation of the monomer,
slow cooling of the composition below the isotropic/nematic transition point at the end of the polymerisation (curing) process in the absence of curing radiation.

11. Electro-optical device comprising a composite material with a holographic grating structure according to any of claims 1 to 8.

12. Electro-optical device according to claim 11, comprising a switchable beam diffractor, a wavelength filter or a beam splitter.
